(19) United States
(12) Patent Application Publication
(10) Pub. No.: US 2017/0014842 A1
(43) Pub. Date: Jan. 19, 2017

(54) WAX SPRAY GUN AND DISPENSING SYSTEM WITH SUCH A WAX SPRAY GUN

(71) Applicants: Lukasz Filip BURZYNSKI, Heilbronn (DE); Claus DREHER, Xaghra (Gozo) (MT)

(72) Inventors: Lukasz Filip BURZYNSKI, Heilbronn (DE); Claus DREHER, Xaghra (Gozo) (MT)

(21) Appl. No.: 15/211,451

(22) Filed: Jul. 15, 2016

(30) Foreign Application Priority Data
Jul. 16, 2015 (DE) 10 2015 213 421.0

(51) Int. Cl. B05B 7/16; B05B 12/00; B05B 15/06

(52) U.S. Cl. CPC B05B 7/1606; B05B 15/061; B05B 7/1693; B05B 12/002

(57) ABSTRACT

A wax spray gun for dispensing corrosion protection wax in spray form including a pistol-grip-like handle and a trigger provided in front of the handle for triggering a dispensing operation. Above the handle, a dispensing subassembly is provided and includes with a mixing-nozzle unit. A dispensing opening, is also provided through which the corrosion protection wax is dispensed in spray form. The wax spray gun additionally includes feed channels for corrosion protection wax and for compressed air, the feed channels opening out into an atomizing chamber of the mixing-nozzle unit, and a heating device, which heats a heating portion of the feed channel for the corrosion protection wax.

### CROSS-REFERENCE TO RELATED APPLICATIONS

This claims priority from German Patent Application No. 10 2015 213 421.0, filed on Jul. 16, 2015, the disclosure of which is hereby incorporated by reference in its entirety into this application.

### APPLICATION AREA AND PRIOR ART

The invention relates to a wax spray gun for dispensing corrosion protection wax in spray form according to the preamble of claim 1, to a dispensing system with a wax spray gun according to the preamble of claim 9, and to a method of dispensing corrosion protection wax in spray form according to the preamble of claim 14.

Corrosion protection wax is used in particular in the manufacture of motor-vehicle bodies. Locations of motor-vehicle bodies and add-on parts, such as doors, which are at risk of corrosion are provided with a layer of this corrosion protection wax, which remains adhering to the respective locations and prevents or reduces the occurrence of corrosion during operation.

Even though, in the modern manufacture of motor-vehicle bodies, corrosion protection wax is usually dispensed via robot-guided dispensing tools, there are cases in which provision is made for manual processing of corrosion protection wax, for example on account of small production numbers or for the purpose of follow-up machining.

### PROBLEM AND SOLUTION

It is a problem of the invention to provide a flexible tool for dispensing corrosion protection wax and a method of using the same.

The problem is solved by a wax spray gun for dispensing corrosion protection wax in spray form according to claim 1.

The wax spray gun comprises a pistol-grip-like handle and a trigger, which is provided in front of the handle and is intended for triggering a dispensing operation. It also comprises, above the handle, a dispensing subassembly with a mixing-nozzle unit, which is followed by a dispensing opening, though which the corrosion protection wax is dispensed in spray form. The wax spray gun comprises feed channels for corrosion protection wax and for compressed air, said feed channels opening out into an atomizing chamber of the mixing-nozzle unit, and also a heating device, by means of which it is possible to heat a heating portion of the feed channel for the corrosion protection wax.

The invention thus relates to a hand-held device for dispensing the corrosion protection wax. Said device has a pistol-like handle, which the operator grips in his hand, and therefore the trigger can be actuated in a known manner by means of the index finger.

This wax spray gun according to the invention dispenses an atomized mixture made up of the corrosion protection wax itself and compressed air. For the purpose of mixing the same, and for generating the desired fine mist, the mixing-nozzle unit is provided with an atomizing chamber, into which compressed air and corrosion protection wax flow.

The wax spray gun is provided for dispensing heated corrosion protection wax. Such a corrosion protection wax is to be processed at temperatures between 40 and 80° C. A preferred wax for use with the wax spray gun is available under the trade name Anticorit DS 329 DE, from Fuchs.

The wax spray gun has the aforementioned heating device for this purpose. Said heating device is provided in the region of the feed channel for the corrosion protection wax and comprises a portion of said feed channel, the heating portion referred to here.

Arranging the heating device directly on the wax spray gun has a series of advantages over the feed of wax which has already been heated. It is thus, in particular, possible to ensure more reliably than in the case of remote heating that the temperature of the corrosion protection wax which is to be dispensed is constant. It is also the case that the local heating of the wax on the wax spray gun itself is advantageous in terms of energy, since the wax can be fed at a temperature of 20° C. to 30° C., and therefore this wax feed gives rise to few energy losses.

The heating device may be part of the dispensing subassembly, which is provided above the handle. It is possible here for the wax spray gun to comprise, on the handle, a connection for the corrosion protection wax, said connection being connected to the feed channel for the corrosion protection wax.

Accordingly, the heating device is provided preferably in the dispensing subassembly, which follows the handle at the top of the latter. This makes it possible for the corrosion protection wax to be directed through the handle, in the direction of the dispensing subassembly, without the handle being heated to any significant extent. It is only on the far side of the handle, on the dispensing subassembly, where heating takes place.

The dispensing subassembly may have a single-piece metal part, in which the feed channels for the compressed air and the corrosion protection wax are provided in each case at least in part and in which the heating portion of the feed channel for the corrosion protection wax is provided.

This construction has proven to be a particularly straightforward one. The aforementioned single-piece metal part is machined preferably in the form of a milling part and contains preferably all of the feed channels, if the latter are part of the dispensing subassembly. Said metal part thus also contains the heating portions of the feed channel for corrosion protection wax. It is therefore possible to achieve technically straightforward heating by way of heating devices, which will be described in more detail hereinbelow, being introduced into the aforementioned metal part, said heating devices heating the metal part in the region of the heating portion. The single-piece metal part preferably also forms the outer contour of the dispensing subassembly.

The heating portion may have an inner volume between 20 and 100 ml, preferably between 30 and 60 ml.

The heating portion, that is to say that region of the feed channel for corrosion protection wax which is heated as part of the heating device, can accommodate, by way of said inner volume, a quantity of wax which is sufficient for a plurality of individual dispensing operations. As will be described in more detail hereinbelow, advantageous functioning of the wax spray gun according to the invention is considered to be that where the wax spray gun discharges discrete volumes of between 5 ml and 10 ml of the corrosion protection wax. The aforementioned inner volume of the heating portion thus allows some of these discrete volumes to be kept in stock. Since the heating device usually has to heat wax at approximately room temperature to approximately 60° C., and this small amount of heating does not require a long period of time, more or less continuous operation is possible as a result of four to ten discrete dispensing volumes being kept in stock.

The dispensing subassembly with integrated heating portion may have an outer surface which is oriented in the direction of the handle and on which are provided elevated contact regions for butting against the handle.

The outer surface oriented in the direction of the handle, and having elevated contact regions, serves to keep the heat transfer to the handle to a low level. In addition, or as an alternative, it is possible to provide insulation means, such as an insulating layer made of material with a low level of thermal conductivity, between the handle and the dispensing subassembly.

The heating device may comprise at least one rod-form heating element, which is pushed into the dispensing subassembly, through an opening in an outer contour of the same, and which has a regulating unit for achieving a defined temperature of the heating portion of the feed channel for corrosion protection wax.

The use of rod-form heating elements, which are available as standard products, means that the heating device can be realized cost-effectively. In addition, maintenance is very straightforward if these rod-form heating elements can be pulled out of the corresponding openings from the outside in order to be exchanged for new ones. In addition, different performance classes for the heating device can be realized comparatively straightforwardly via easily interchangeable rod-form heating elements which are pushed in from the outside.

The trigger may be provided with an electric trigger switch, which generates an electric signal when the trigger is actuated.

The use of an electric switch which is activated when the trigger is actuated, and of which the output signal is used to open a switching valve or to activate a delivery device, allows for specific operating modes, as will be explained in more detail hereinbelow. As an alternative to this, however, provision could also be made for the trigger to open the feed channel for compressed air and/or the feed channel for corrosion protection wax mechanically by means of corresponding mechanically actuatable valves.

For the purpose of influencing the dispensing of corrosion protection wax in spray form, the mixing-nozzle unit may comprise an interchangeable nozzle component. To this end, it is possible for the dispensing subassembly to have a recess, into which the interchangeable nozzle component can be introduced in order to be fixed in position there by a securing element.

In order for it to be possible for the same wax spray gun to be used for different application purposes, it is advantageous for the nozzle components to be provided in straightforwardly interchangeable form. The operations of introducing the nozzle component into an appropriate recess and of fixing the nozzle component there by means of the securing element have proven successful for this purpose. The securing element may be, in particular, an end portion of a dispensing channel, through which the spray jet is dispensed.

The mixing-nozzle unit may comprise an outlet valve, which can be switched in a pressure-dependent manner, is arranged upstream of the atomizing chamber and controls the inflow of corrosion protection wax.

The pressure-dependently switching outlet valve in the region of the mixing-nozzle unit makes it possible to define a minimum pressure at which the corrosion protection wax is fed to the atomizing chamber. This provides, in particular, for the defined start and end of a dispensing operation, without a transition phase with increasing and decreasing dispensing pressure.

The problem is also solved by a dispensing system with a wax spray gun according to claim 9.

The dispensing system has a delivery device with connections for compressed air and corrosion protection wax. The dispensing system also has a wax spray gun of the type described. The delivery device and the wax spray gun are connected to one another via a respective line for compressed air and corrosion protection wax.

The aforementioned delivery device, which may preferably also have a delivery pump or a compressor for the pressure activation of the corrosion protection wax or of the compressed air, may be designed in the form of a separate unit, which is connected to the wax spray gun via hose lines. However, it is also conceivable to have configurations in which the delivery device, or a part of the delivery device, is part of the wax spray gun itself or is fitted, for example, on the handle of the same.

The trigger of the wax spray gun may be provided with an electric trigger switch. The delivery device may have at least one electrically switchable valve for controlling inflow of compressed air and/or corrosion protection wax to the wax spray gun, it being possible for the wax spray gun and the electrically switchable valve of the delivery device to be connected to one another via a signal line.

The delivery device can use the switchable valves to control specifically the delivery of corrosion protection wax and/or compressed air. This takes place usually in reaction to an actuation of the trigger of the wax spray gun.

It is possible for the delivery device to have a respective electrically switchable valve for controlling inflow of compressed air and corrosion protection wax to the wax spray gun, and for the dispensing system to have a control device for controlling the electrically switchable valves in reaction to the actuation of the trigger of the wax spray gun.

This control device may be designed so that, when the trigger is actuated, it opens first of all the valve for the compressed air and then the valve for the corrosion protection wax and/or, towards the end of a dispensing operation, it closes first of all the valve for the corrosion protection wax and then the valve for the compressed air.

A delayed start of the feed of corrosion protection wax can give rise to a particularly advantageous spray pattern, since the compressed-air stream starting up has already stabilized when the corrosion protection wax is fed for the first time. The continued feeds of compressed air following completion of the delivery of corrosion protection wax serves the purpose of freeing the atomizing chamber from residues of the corrosion protection wax before the dispensing operation ends.

The control device may be designed so that, when the trigger is actuated, it opens the valve for corrosion protection wax and, once a quantity of between 3 ml and 20 ml, in particular between 5 ml and 10 ml, of the corrosion protection wax has flowed through, it closes the valve again.

Accordingly, the control device designed in this way is not configured to give rise to a continuous stream of corrosion protection wax for the duration of trigger actuation. Rather, the delivery of corrosion protection wax ends after an at least approximately defined quantity of corrosion protection wax has been discharged. This makes it possible for approximately equal quantities to be dispensed in a reproducible manner without it being necessary to rely on the reaction speed of the operator.

The problem is also solved by a method of dispensing corrosion protection wax in spray form.

The dispensing takes place here using a wax spray gun or a dispensing system of the type described.

The method according to the invention is implemented, in particular, for applying corrosion protection to motor-vehicle body parts and to add-on parts, such as doors.

The dispensing can take place in discrete, individual dispensing operations each with a dispensing volume between 3 ml and 20 ml, in particular between 5 ml and 10 ml.

The dispensing can take place with the corrosion protection wax at a temperature between 40° C. and 80° C. A wax which is suitable for this purpose is available under the name Anticorit DS 329 DE, from Fuchs.

### BRIEF DESCRIPTION OF THE DRAWINGS

Further advantages and aspects of the invention can be gathered from the claims and from the following description of a preferred exemplary embodiment of the invention, this exemplary embodiment being explained hereinbelow with reference to the figures, in which:

FIG. 1 shows a dispensing system for dispensing corrosion protection wax, having a delivery device and a wax spray gun connected thereto,

FIG. 2 shows a sectional illustration of the dispensing subassembly of the wax spray gun,

FIG. 3 shows an exploded illustration of the dispensing subassembly of FIG. 2, and

FIGS. 4 and 5 respectively show the dispensing subassembly in an illustration as seen obliquely from above and as seen obliquely from beneath.

### DETAILED DESCRIPTION OF THE EXEMPLARY EMBODIMENTS

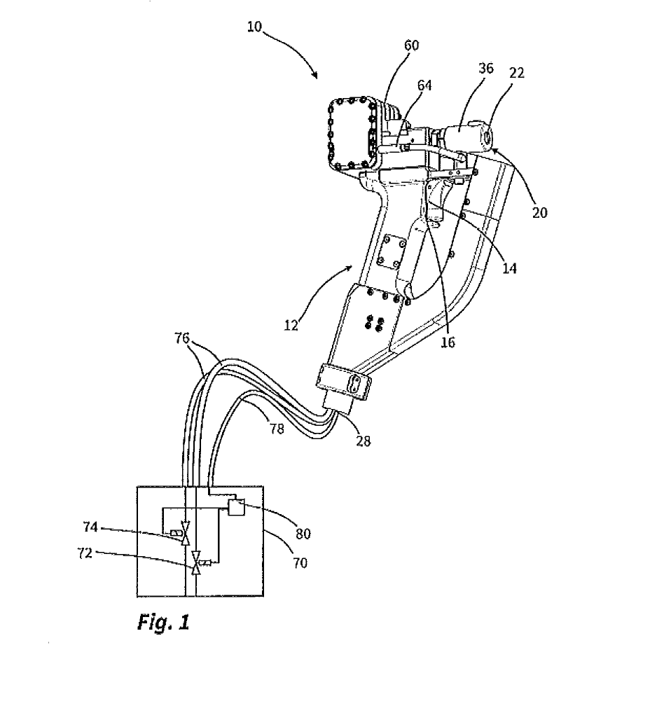

FIG. 1 shows a dispensing system for dispensing corrosion protection wax. Said dispensing system comprises a wax spray gun 10, which is connected to a delivery device 70 via fluid lines 76 and a signal line 78.

The dispensing system serves to dispense atomized corrosion protection wax by means of the wax spray gun 10. The wax spray gun 10 therefore has, in a manner similar to a pistol, a handle 12 which is intended to be gripped by one hand so that the index finger can actuate the trigger 14 and a trigger switch 16 is closed as a result. The handle is followed at the top by a dispensing subassembly 20, which will be explained in detail in the rest of the figures.

The delivery device 70, which is illustrated schematically in FIG. 1, has delivery pumps or the like (not illustrated specifically) for corrosion protection wax and compressed air. It also has two switchable valves 72, 74 which, activated by a control device 80, can be opened and closed. The control device 80 is connected to the wax spray gun 10, and there to the trigger switch 16, via the aforementioned signal line 78. The fluid lines 76 for spray wax and compressed air are provided on the far side of said valves 72, 74 and supply the wax spray gun, in dependence on the switching state of the respective valves, with corrosion protection wax and compressed air. These lines 76 are connected to the handle 12 at the lower end thereof. Lines through which the compressed air and the corrosion protection wax are fed to the dispensing subassembly 20 are provided in the handle 12 in a manner which is not illustrated specifically.

The dispensing subassembly 20, in a manner which will be explained hereinbelow, has a mixing-nozzle unit with an atomizing chamber, in which the corrosion protection wax is nebulized finely by means of the compressed air and discharged through the dispensing opening 22. The dispensing subassembly 20 also has a heating device 60, of which the core component is formed by rod-form heating elements 64, which are supplied with power and contain a regulating device in order to ensure a constant temperature.

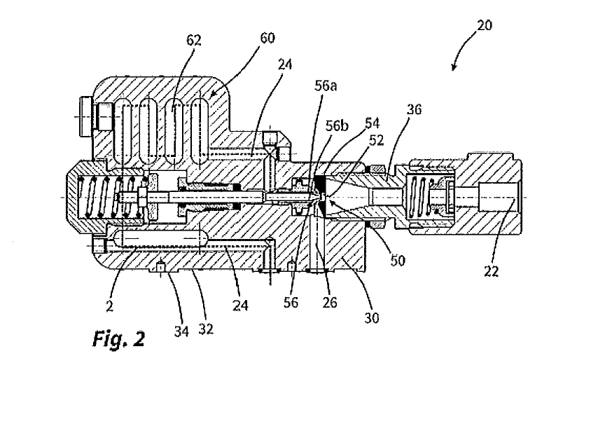

FIG. 2 shows a sectional view of the dispensing subassembly 20. The latter contains a feed channel 24, which provides for the feed of corrosion protection wax to the mixing-nozzle unit 50 along the dashed-line path 2, not all of which is located in the section plane. Corrosion protection wax flowing through the handle 12 passes, along this path, first of all to the heating device 60, where it is heated to approximately 60° C. within a heating portion 62 with a volume of approximately 50 ml. Before it enters into the atomizing chamber 52, the corrosion protection wax also passes through a pressure-dependently switching valve 56, comprising a valve seat 56a and a spring-loaded valve-closing pin 56b. It is only at a sufficient level of pressure that the valve opens and allows the heated corrosion protection wax to pass into the atomizing chamber 52. The compressed air fed is fed through the feed channel 26 directly to the atomizing chamber 52. The corrosion protection wax and the compressed air pass through a nozzle opening within a nozzle component 54. By virtue of the pressure of the compressed air, the corrosion protection wax is atomized and dispensed through the dispensing opening 22.

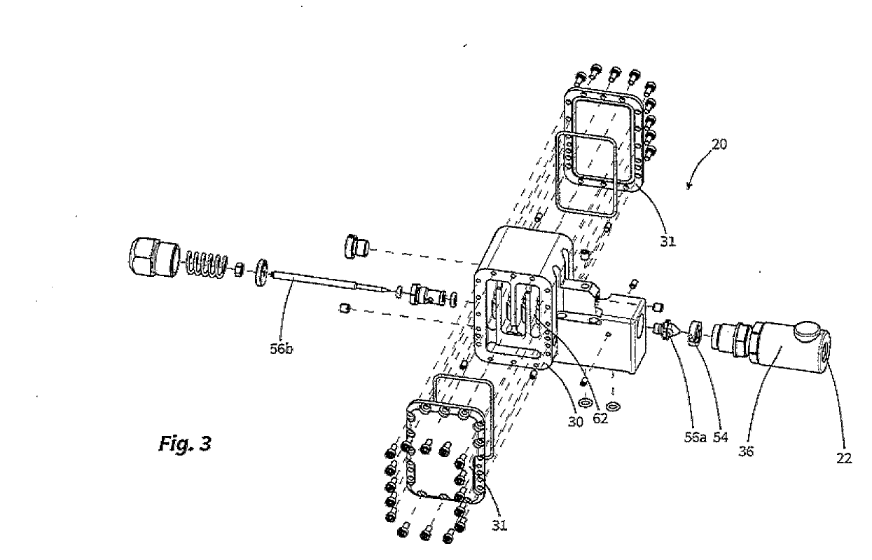

The individual components of the dispensing subassembly 20 can be gathered from the exploded illustration of FIG. 3. This illustration illustrates a multiplicity of different nozzle components 54, only one of which is used at any one time. However, the straightforward exchange of said nozzle components allows for a likewise straightforward adaptation to the dispensing characteristics which are desired in each case. Referring once again to FIG. 2, the nozzle component 54 selected is fixed in the intended position by means of a securing element 36. In this case, said securing component 36 is also that component which makes available part of the dispensing channel in the direction of the dispensing opening 22.

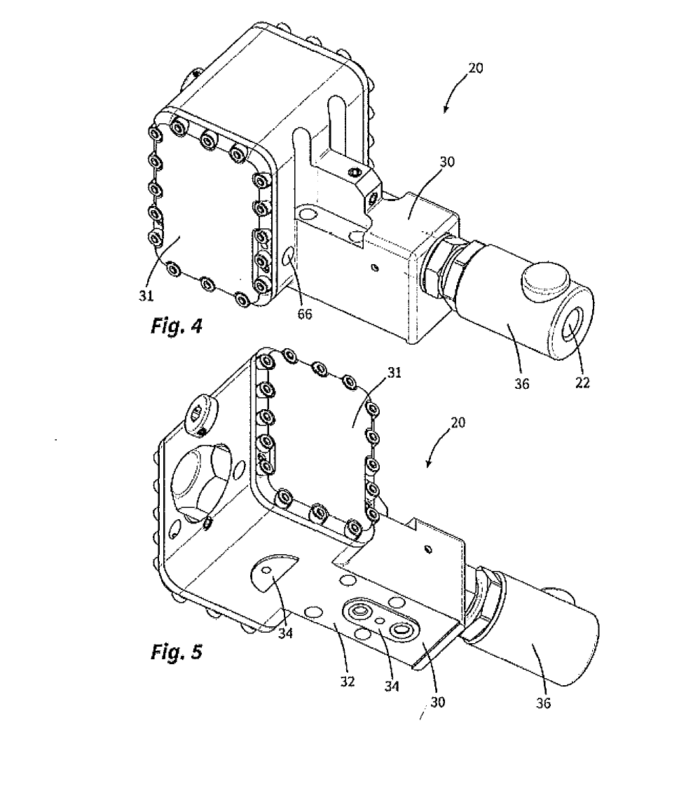

FIGS. 4 and 5 once again show the dispensing subassembly, this time as seen obliquely from above and as seen obliquely from beneath.

The locations where openings 66 are provided for accommodating the rod-form heating elements can be gathered from FIG. 4 in particular. FIG. 5 shows the underside of the dispensing subassembly 20 and in particular the lower termination surface 32, which is elevated in two regions 34. This ensures just minimal contact between the dispensing subassembly 20 and the handle 12.

It is therefore possible for only a small amount of the heat which is fed via the heating elements 64 in order to heat the corrosion protection wax to pass into the handle 12. This allows for a relatively long period of use without the handle 12 heating uncomfortably.

The intended use of the wax spray gun for dispensing the corrosion protection wax makes provision, in particular, for discrete portions of the corrosion protection wax to be dispensed thereby. It is thus possible for the control device 80 to operate, in particular, such that, in reaction to the actuation of the trigger 14 of the wax spray gun 10, first of all the compressed-air valve 72 is opened. It is only a short period of time later that the valve 74 for the corrosion protection wax opens, as a result of which corrosion protection wax is fed from the heating portion 62 of the feed channel 24 to the mixing-nozzle unit 50 and is atomized here by the already previously initiated air stream. Once a small quantity of, for example, 5 to 10 ml of the corrosion protection wax has been discharged, the control device 80 closes the valve 74, and therefore the inflow of corrosion protection wax ends. This takes place irrespective of whether the trigger switch 16 is still actuated. Following another short period of time, once the feed of corrosion protection wax has been interrupted and, on account of the valve 56 opening in a pressure-dependent manner, there is therefore no longer any corrosion protection wax being fed to the mixing-nozzle unit, the compressed-air valve 72 also closes. The short phase of compressed air remaining active following termination of the feed of corrosion protection wax serves to free the mixing-nozzle unit of any remaining corrosion protection wax.

It is only when the trigger is next actuated that the operation described is repeated.

Since the heating portion 62 in the feed channel 24 has an inner volume which allows approximately five to ten such discrete dispensing operations, it is possible for the wax spray gun to be used continually every few seconds. The heating device is sufficiently powerful in order for the corrosion protection wax which flows into the heating portion to be heated to a sufficient extent until it is dispensed together with compressed air.

1. Wax spray gun for dispensing corrosion protection wax in spray form, having the following features:
a. the wax spray gun comprises a pistol-grip-like handle and a trigger, which is provided in front of the handle and is intended for triggering a dispensing operation, and
b. the wax spray gun comprises, above the handle, a dispensing subassembly with a mixing-nozzle unit, which is followed by a dispensing opening, through which the corrosion protection wax is dispensed in spray form, and
c. the wax spray gun comprises feed channels for corrosion protection wax and for compressed air, said feed channels opening out into an atomizing chamber of the mixing nozzle unit, and
d. the wax spray gun comprises a heating device, to heat a heating portion of the feed channel for the corrosion protection wax.

2. Wax spray gun according to claim 1, having the following feature:
a. the heating device is part of the dispensing subassembly, which is provided above the handle.

3. Wax spray gun according to claim 2, having the following feature:
a. the wax spray gun comprises, on the handle, a connection for the corrosion protection wax, said connection being connected to the feed channel for the corrosion protection wax.

4. Wax spray gun according to claim 1, having the following feature:
a. the dispensing subassembly comprises a single-piece metal part, in which the feed channels for the compressed air and the corrosion protection wax are provided in each case at least in part and in which the heating portion of the feed channel for the corrosion protection wax is provided.

5. Wax spray gun according to claim 1, having at least one of the following features:
a. the heating portion has an inner volume between 20 and 100 ml, preferably between 30 and 60 ml, or
b. the dispensing subassembly with integrated heating portion has an outer surface which is oriented in the direction of the handle and on which are provided elevated contact regions for butting against the handle, or
c. the heating device comprises at least one rod-form heating element, which is pushed into the dispensing subassembly, through an opening in an outer contour of the same, and which has a regulating unit for achieving a defined temperature of the heating portion of the feed channel for corrosion protection wax.

6. Wax spray gun according to claim 1, having the following feature:
a. the trigger is provided with an electric trigger switch, which generates an electric signal when the trigger is actuated.

7. Wax spray gun according to claim 1, having the following features:
a. for the purpose of influencing the dispensing of corrosion protection wax in spray form, the mixing-nozzle unit comprises an interchangeable nozzle component, and
b. the dispensing subassembly has a recess, into which the interchangeable nozzle component can be introduced in order to be fixed in position there by a securing element.

8. Wax spray gun according to claim 1, having the following feature:
a. the mixing-nozzle unit comprises an outlet valve, which can be switched in a pressure-dependent manner, is arranged upstream of the atomizing chamber and controls the inflow of corrosion protection wax.

9. Dispensing system with a wax spray gun, having the following features:
a. the dispensing system has a delivery device with connections for compressed air and corrosion protection wax, and
b. the dispensing system has a wax spray gun according to claim 1, and
c. the delivery device and the wax spray gun are connected to one another via a respective line for compressed air and corrosion protection wax.

10. Dispensing system according to claim 9, having the following features:
a. the trigger of the wax spray gun is provided with an electric trigger switch, and
b. the delivery device has at least one electrically switchable valve for controlling inflow of compressed air and/or corrosion protection wax to the wax spray gun, and
c. the trigger switch of the wax spray gun and the electrically switchable valve of the delivery device are connected to one another via a signal line.

11. Dispensing system according to claim 10, having the following features:
a. the delivery device has a respective electrically switchable valve for controlling inflow of compressed air and corrosion protection wax to the wax spray gun, and
b. the dispensing system has a control device for controlling the electrically switchable valves.

12. Dispensing system according to claim 11, having the following feature:
a. the control device is designed so that,
when the trigger is actuated, it opens first of all the valve for the compressed air and then the valve for the corrosion protection wax and/or,
towards the end of a dispensing operation, it closes first of all the valve for the corrosion protection wax and then the valve for the compressed air.

13. Dispensing system according to claim 11, having the following feature:
a. the control device is designed so that, when the trigger is actuated, it opens the valve for corrosion protection wax and, once a quantity of between 3 ml and 20 ml, in particular between 5 ml and 10 ml, of the corrosion protection wax has flowed through, it closes the valve again.

14. Method of dispensing corrosion protection wax in spray form, having the following feature:
a. the dispensing takes place using a wax spray gun or a dispensing system according to claim 1.

15. Method according to claim 14, having at least one of the following features:
a. when the method is being implemented, corrosion protection wax is dispensed, or
b. the dispensing takes place in discrete, individual dispensing operations each with a dispensing volume between 3 ml and 20 ml, in particular between 5 ml and 10 ml, or
c. the dispensing takes place with the corrosion protection wax at a temperature between 40° C. and 80° C.
